(19) United States
(12) Patent Application Publication
(10) Pub. No.: US 2003/0180599 A1
(43) Pub. Date: Sep. 25, 2003

(54) Fuel cell power plant

(76) Inventor: Tetsuya Kamihara, Yokohama-shi Kanagawa (JP)

Correspondence Address: MCDERMOTT WILL & EMERY, 600 13TH STREET, N.W., WASHINGTON, DC, 20005-3096, US

(21) Appl. No.: 10/362,440

(22) PCT Filed: Sep. 20, 2002
(86) PCT No.: PCT/JP02/09663

(30) Foreign Application Priority Data
Nov. 16, 2001 (JP) 2001-350994

(51) Int. Cl. H01M 8/04

(52) U.S. Cl. 429/34; 429/23; 429/25

(57) ABSTRACT

A fuel cell stack (1) generates electric power by reacting air with hydrogen supplied from a hydrogen supply passage (4) and recirculates anode effluent resulting from power generation operations to the hydrogen supply passage (4) through a recirculation passage (8) via an ejector (10). A valve (12, 20) is provided for supplying hydrogen from the hydrogen supply passage (4) to the fuel cell stack (1) by bypassing the ejector (10). A controller (7) maintains the anode effluent recirculation performance of the ejector (10) when the hydrogen flow amount in the hydrogen supply passage (4) is small by regulating the opening of the valve (12, 20). When the hydrogen flow amount is large, the pressure in the hydrogen supply passage (4) upstream of the ejector (10) is prevented from excessive increases.

### FIELD OF THE INVENTION

This invention relates to the recirculation of anode effluent discharged from a fuel cell stack to a hydrogen supply passage.

### BACKGROUND OF THE INVENTION

Tokkai 10-284098 published by the Japanese Patent Office in 1998 discloses a fuel cell power plant that is provided with an ejector for recirculating hydrogen discharged from the anode of a fuel cell stack to a hydrogen supply passage connected to the anode.

In a polymer electrolyte fuel cell which generates power using humidified hydrogen, an excess amount of hydrogen is supplied to the anode of the fuel cell in order to realize an overall high reaction efficiency and to prevent steam for humidifying hydrogen from condensing and remaining in the cell. As a result, the anode effluent discharged from the anode contains a high level of hydrogen and therefore a recirculation mechanism is provided in the prior-art power plant in order to re-use this anode effluent.

### SUMMARY OF THE INVENTION

When the fuel cell power plant is used to supply the motive power for a vehicle, the power generation load is varied in response to the running state of the vehicle. This causes considerable variation in the hydrogen flow rate in the hydrogen supply passage. During low-load operation, the hydrogen flow rate in the hydrogen supply passage is small and a required velocity head that is required by the ejector to recirculate anode effluent into the hydrogen supply passage can not be obtained. If a small capacity ejector is used, anode effluent can be ejected into the hydrogen supply passage even when the velocity head of hydrogen flow is small, but a small capacity ejector can not eject the large amounts of anode effluent into the hydrogen supply passage required during high load operation. Furthermore since the pressure loss that occurs in the hydrogen flow associated with a small capacity ejector is large, when the hydrogen flow rate in the hydrogen supply passage increases, the pressure in the hydrogen supply passage upstream of the ejector undergoes a large increase. Therefore when a small capacity ejector is used, the pressure resistant performance of the hydrogen supply passage upstream of the ejector must be improved.

Thus, the performance of an ejector using the velocity head of the hydrogen supply passage tends to fluctuate in response to the flow velocity of hydrogen and this causes large pressure variations in the hydrogen supply passage.

It is therefore an object of this invention to ensure the performance of an ejector with respect to a small hydrogen flow rate while preventing excessive pressure increase in a hydrogen supply passage resulting from the large hydrogen flow rate.

In order to achieve the above object, this invention provides a fuel cell power plant comprising a fuel cell stack which generates an electric power by the reaction of air with hydrogen and discharges anode effluent which contains hydrogen, a hydrogen supply passage which supplies hydrogen to the fuel cell stack, a recirculation passage collecting the anode effluent discharged from the fuel cell stack, an ejector installed in the hydrogen supply passage and ejecting the anode effluent from the recirculation passage into the hydrogen supply passage using a velocity head of hydrogen in the hydrogen supply passage, and a valve which bypasses the ejector and supplies hydrogen in the hydrogen supply passage upstream of the ejector to the fuel cell stack without passing through the ejector.

The details as well as other features and advantages of this invention are set forth in the remainder of the specification and are shown in the accompanying drawings.

### BRIEF DESCRIPTION OF THE DRAWINGS

FIG. 1 is a schematic diagram of a fuel cell power plant according to this invention.

FIG. 2 is a flowchart describing a control routine for a bypass valve executed by a controller according to this invention.

FIGS. 3A and 3B are diagrams showing the variation in hydrogen recirculation rate of the fuel cell power plant and the variation in pressure upstream of an ejector with respect to hydrogen flow rate in a fuel supply passage.

FIG. 4 is a schematic diagram of a fuel cell power plant according to a second embodiment of this invention.

FIG. 5 is similar to FIG. 2, but showing the second embodiment of this invention

FIG. 6 is a schematic diagram of a fuel cell power plant according to a third embodiment of this invention.

FIG. 7 is a flowchart showing a control routine for a bypass valve executed by a controller according to the third embodiment of this invention.

FIG. 8 is a schematic diagram of a fuel cell power plant according to a fourth embodiment of this invention.

FIG. 9 is a flowchart showing a throttle control routine executed by a controller according to the fourth embodiment of this invention.

FIG. 10 is a diagram showing the relationship of a throttle opening and a load on the fuel cell stack according to the fourth embodiment of this invention.

FIG. 11 is a schematic diagram of a fuel cell power plant according to a fifth embodiment of this invention.

FIG. 12 is similar to FIG. 9, but showing the fifth embodiment of this invention.

FIG. 13 is a diagram showing the characteristics of a map of a throttle opening stored in a controller according to the fifth embodiment of this invention.

FIGS. 14A-14C are diagrams showing the relationship of a pressure in a hydrogen supply passage upstream of an ejector, a hydrogen recirculation rate, the throttle opening and a hydrogen supply amount in the fuel cell power plant according to the fifth embodiment of this invention.

FIG. 15 is a schematic diagram of a fuel cell power plant according to a sixth embodiment of this invention.

FIG. 16 is a flowchart showing a throttle control routine executed by a controller according to the sixth embodiment of this invention.

### DESCRIPTION OF THE PREFERRED EMBODIMENTS

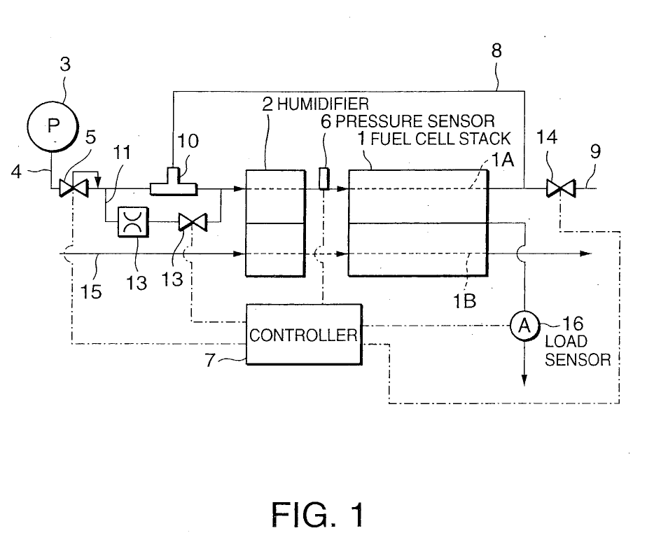

Referring to FIG. 1 of the drawings, a fuel cell stack 1 mounted in a vehicle as a source of motive power is a known fuel cell stack comprising a laminate of solid polymer fuel cells. The fuel cell stack 1 is provided with an anode 1A and a cathode 1B. Power is generated by reacting hydrogen supplied to the anode 1A with air supplied to the cathode 1B.

Hydrogen is supplied to the anode 1A from a hydrogen tank 3. Air is supplied to the cathode 1B from an air supply passage 15. Before entering the fuel cell stack 1, the air and hydrogen are respectively humidified by a humidifier 2. The air and hydrogen in the humidifier 2 respectively come into contact with pure water through a semi-permeable membrane and are humidified by water molecules passing through the semi-permeable membrane.

A pressure control valve 5 and an ejector 10 are provided in a hydrogen supply passage 4 between the hydrogen tank 3 and the humidifier 2.

A discharge passage 9 provided with a purge valve 14 is connected to the anode 1A of the fuel cell stack 1. The purge valve 14 discharges anode effluent resulting from power generation operations in the fuel cell stack 1. A recirculation passage 8 is connected to the discharge passage 9 upstream of the purge valve 14 in order to recirculate anode effluent from the discharge passage 9 to the hydrogen supply passage 4 through the ejector 10.

The purge valve 14 is normally closed and opens under the following conditions. Hydrogen contained in the hydrogen tank 3 contains trace amounts of impurities such as nitrogen (N2) or carbon monoxide (CO). Although hydrogen is consumed by the power generation operations in the fuel cell stack 1, such impurities accumulate in the power plant and have an adverse effect on the power generation performance of the fuel cell stack 1. Consequently impurities which have accumulated in the power plant may be discharged to the outside of the fuel cell power plant by periodically opening the purge valve 14 during fuel cell operation.

Further, when the fuel cell power plant is started up, air is accumulated in the power plant components including the fuel cell stack 1. This residual air is scavenged by hydrogen supplied from the hydrogen tank 3 and the purge valve 14 is opened to perform purging operations to the outside of the power plant.

The hydrogen supply passage 4 is provided with a bypass passage 11 in order to bypass the ejector 10. A solenoid bypass valve 12 is provided in series with an orifice 13 in the bypass passage 11.

The capacity of the ejector 10 is preferably a capacity which can maintain a preferred recirculation amount when the bypass valve 12 is closed during low-load operation. That is to say, the capacity of the ejector 10 is determined based on the flow rate of the hydrogen supply passage 14 during low-load operation as a standard. The orifice 13 has dimensions which produce a pressure loss which is substantially equal to the pressure loss produced by the ejector 10 for a same flow rate.

The opening and closing of the pressure control valve 5, the bypass valve 13 and the purge valve 14 are controlled in response to signals from a controller 7. The controller 7 comprises a microcomputer provided with a central processing unit (CPU), a read only memory (ROM), a random access memory (RAM) and an input/output interface (I/O interface). The controller may comprise a plurality of microcomputers.

In order to control the respective valves, the controller 7 is provided with input data in the form of signals from a pressure sensor 6 which detects a hydrogen pressure supplied to the fuel cell stack 1 from the humidifier 2 and a load sensor 16 which detects a power generation load on the fuel cell stack 1.

The controller 7 controls the degree of opening of the pressure control valve 5 so that the detected pressure of the pressure sensor 6 coincides with a predetermined pressure. The controller 7 also controls the recirculation amount of anode effluent by opening and closing the bypass valve 12 in response to the power generation load on the fuel cell stack 1 which is detected by the load sensor 7. This control is performed with the purge valve 14 closed.

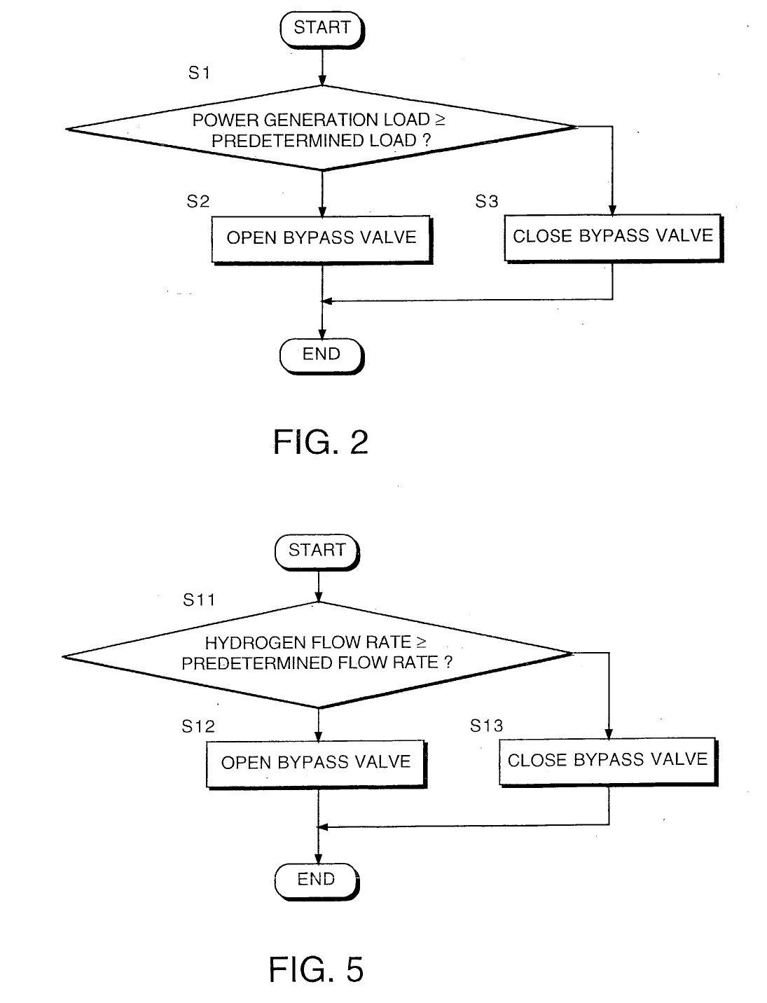

Referring to FIG. 2, a control routine for the anode effluent recirculation amount executed by the controller 7 will be described. This routine is performed at intervals of ten milliseconds during operation of the fuel cell power plant with the purge valve 14 closed. The performance conditions for control routines described with respect to the following embodiments are all the same.

Firstly in a step S1, the controller 7 determines whether or not the power generation load on the fuel cell stack 1 has reached a predetermined load. The supply amount of hydrogen to the fuel cell stack 1 is increased in response to the power generation load on the fuel cell stack 1. The predetermined load corresponds to the power generation load of the fuel cell stack 1 when the pressure in the hydrogen supply passage 4 upstream of the ejector 10 reaches a pre-set upper limit for pressure resistant characteristics. The predetermined load is determined in advance on the basis of experimentation.

In the step S1, when the power generation load has reached the predetermined load, the controller 7 proceeds to a step S2 and opens the bypass valve 12.

In the step S1, when the power generation load has not reached the predetermined load, the controller 7 proceeds to a step S3 and closes the bypass valve 12.

After the operation in the step S2 or the step S3, the controller 7 terminates the routine.

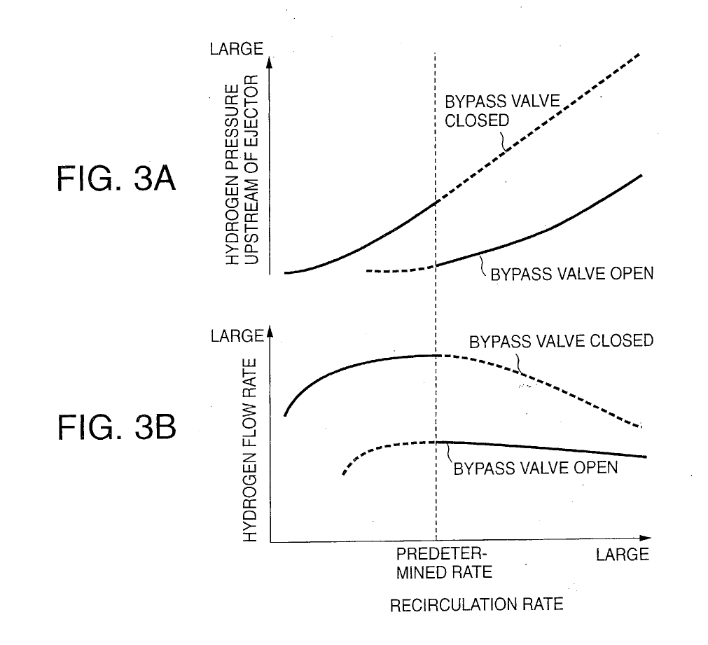

The hydrogen supply amount to the fuel cell stack 1 is increased in response to the power generation load as described above. Referring to FIGS. 3A and 3B, the dotted vertical line across the figures shows a hydrogen supply amount corresponding to the predetermined power generation load.

When the bypass valve 12 is opened, the pressure loss resulting from hydrogen supply is reduced by allowing a part of the hydrogen supplied from the hydrogen tank 3 to flow in the bypass passage 11. As a result, the pressure in the hydrogen supply passage upstream of the ejector 10 can be reduced as shown in FIG. 3A with respect to the same supply amount of hydrogen. Conversely, since the flow speed of hydrogen passing through the ejector 10 is reduced due to the expansion of the passage, the velocity head in the hydrogen supply passage 4 which can be used by the ejector 10 in order to eject anode effluent in the recirculation passage 8 towards the hydrogen supply passage 4 is also reduced. This has the result that the recirculation rate representing the ratio of the hydrogen supply amount from the hydrogen tank 3 and the anode effluent recirculation amount to the hydrogen supply passage from the recirculation passage 8 can be reduced as shown in FIG. 3B by opening the bypass valve 12.

The bypass valve 12 is maintained in the closed position while the controller 7 is performing the above control routine until the hydrogen supply amount reaches the predetermined load equivalence amount shown by the dotted line in the figure. As a result, the flow speed in the hydrogen supply passage 4 is high in comparison with the case in which the bypass valve 12 is opened. Consequently it is possible to supply the velocity head required for the injection of anode effluent to the ejector 10. Therefore the ejector 10 can also recirculate sufficient anode effluent to the hydrogen supply passage 3 under low power generation load conditions. Furthermore the power generation efficiency can be maintained to a high level by re-using the anode effluent.

On the other hand, when the hydrogen supply amount has reached the predetermined load equivalence amount shown by the dotted line in the figure, the bypass valve 12 is opened. As a result, a part of the hydrogen is supplied through the bypass passage 11 to the humidifier 2 and the pressure loss obtained by the ejector 10 as a result of hydrogen flow is low in comparison to the case when the bypass valve 12 is closed. Therefore it is possible to transfer large amounts of hydrogen to the humidifier 2 without an excessive increase in the pressure in the hydrogen supply passage 3 upstream of the ejector 10 as shown in FIG. 3A.

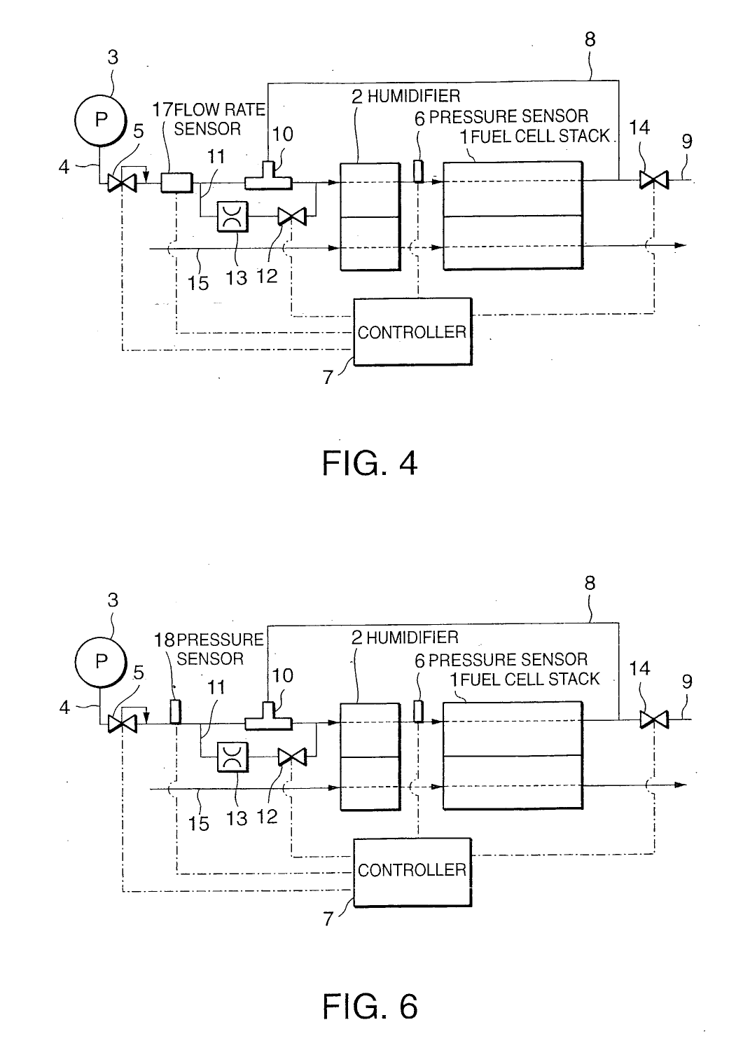

A second embodiment of this invention will be described referring to FIGS. 4 and 5.

Firstly referring to FIG. 4, a flow rate sensor 17 is provided in this embodiment in the hydrogen supply passage 4 upstream of the bypass passage 11 in order to detect the hydrogen supply flow rate from the hydrogen tank 3, while the load sensor 16 of first embodiment is omitted instead. Other aspects of the hardware structure are the same as those described with reference to the first embodiment.

The controller 7 executes the routine shown in FIG. 5 instead of the routine of FIG. 2 of the first embodiment in order to control the opening and closing of the bypass valve 12. The execution conditions for this routine are the same as those for the routine shown in FIG. 2.

Firstly the controller 7 compares the hydrogen flow rate detected by the flow rate sensor 17 with a predetermined flow rate in a step S11.

The predetermined flow rate is determined in the following manner. That is to say, the predetermined flow rate is taken to be a flow rate when the pressure in the hydrogen supply passage 4 upstream of the ejector 10 with the bypass valve 12 closed reaches a pre-set upper limit for pressure resistance. The predetermined flow rate is determined by calculation or by experiment.

In the step S11, when the hydrogen flow rate has reached the predetermined flow rate the controller 7 proceeds to a step S12 and opens the bypass valve 12.

In the step S11, when the hydrogen flow rate has not reached the predetermined flow rate the controller 7 closes the bypass valve 12 in a step S13.

After the process in the step S12 or the step S13, the controller 7 terminates the routine.

In the same manner as the first embodiment, this embodiment also maintains the recirculation amount of anode effluent at low loads while preventing excessive increase in the pressure in the hydrogen supply passage 4 at high loads.

The solid polymer fuel cell generally displays a higher power generation efficiency when the air and hydrogen are supplied at high pressure during high power generation load. However when the power generation load is low, the pressure of supplied air and hydrogen has little effect on the power generation efficiency and energy efficiency is higher at low pressures when the energy used for pressurizing is taken into account. As a result, it is preferred that in low load regions, the supply pressure of air and hydrogen is suppressed to a low level and in high load regions, the supply pressure for air and hydrogen is increased.

However when this type of control is employed, the balance between the hydrogen supply amount to the fuel cell stack 1 and the power generation load on the fuel cell stack 1 is lost during transient operating conditions resulting from load fluctuations. For example, when the load increases, in addition to the increase in the hydrogen supply amount in order to meet the increase in the hydrogen consumption amount, it is necessary to increase the hydrogen supply amount in order to increase in the hydrogen supply pressure. Conversely during decreases in load, in addition to the decrease in the hydrogen supply amount corresponding to the decrease in the hydrogen consumption amount, it is necessary to decrease the hydrogen supply amount in order to decrease the hydrogen supply pressure.

When the opening of the pressure control valve 5 is controlled in order to meet the above requirements, in this embodiment, the bypass valve 12 is opened and closed in response to the hydrogen flow rate in the hydrogen supply passage 4 rather than opening and closing the bypass valve 12 in response to the power generation load on the fuel cell stack 1 as the first embodiment. Opening and closing the bypass valve 12 in response to the hydrogen flow rate allows for more accurate control of the pressure in the hydrogen supply passage 4 upstream of the ejector 10 during transient operating conditions.

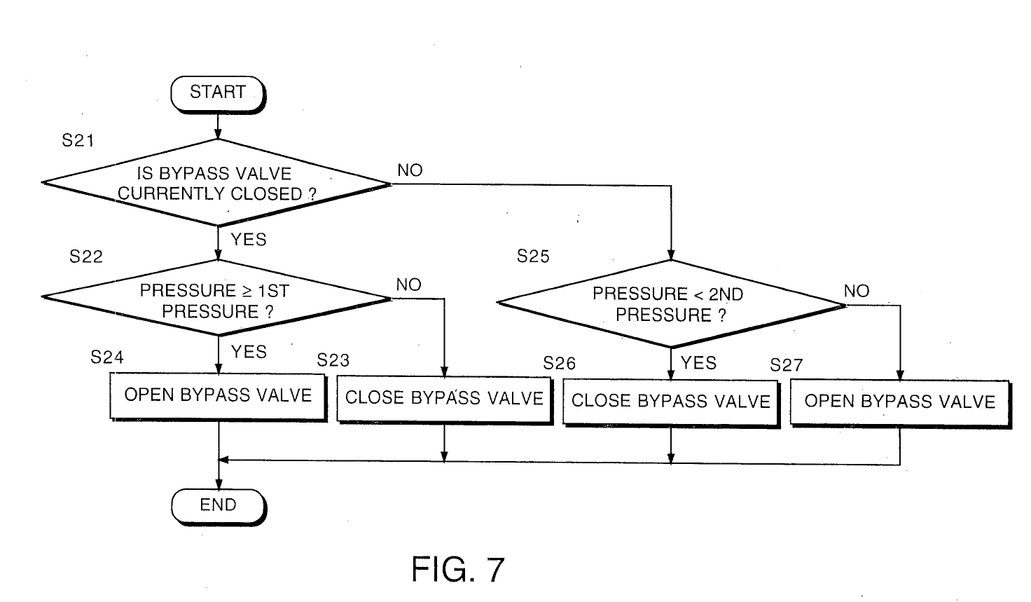

Referring to FIGS. 6 and 7, a third embodiment of this invention will be described.

Firstly with reference to FIG. 6, in this embodiment, a pressure sensor 18 is provided instead of the flow rate sensor 17 of the second embodiment. Other aspects of the hardware structure are the same as those described with reference to the second embodiment.

The controller 7 executes the routine shown in FIG. 7 instead of the routine shown in FIG. 5 of the second embodiment.

Referring to FIG. 7, the controller 7 firstly determines whether or not the bypass valve 12 is currently closed in a step S21.

When the bypass valve 12 is closed, in a step S22, it is determined whether or not the pressure in the hydrogen supply passage 4 upstream of the ejector 10 detected by the pressure sensor 18 has reached a first predetermined pressure. The first predetermined pressure is a pressure which is pre-set in response to the upper limiting pressure for pressure resistance as described above.

When the detected pressure from the pressure sensor 18 has reached the first predetermined pressure, the controller 7 opens the bypass valve 12 in a step S24. When the detected pressure from the pressure sensor 18 has not reached the first predetermined pressure, the controller 7 closes the bypass valve 12 in a step S23.

On the other hand, when the bypass valve 12 is currently open in the step S21, the controller 7 compares the detected pressure from the pressure sensor 18 in a step S25 with a second predetermined pressure. The second predetermined pressure is set to a smaller value than the first predetermined pressure.

When the detected pressure of the pressure sensor 18 is lower than the second predetermined pressure, the controller 7 closes the bypass valve 12 in a step S26. When the detected pressure from the pressure sensor 18 is not lower than the second predetermined pressure, the controller 7 opens the bypass valve 12 in a step S27.

After any of the processes in the steps S23, S24, S26 or S27 are performed, the controller 7 terminates the routine.

The relationship of the hydrogen flow rate to the pressure in the hydrogen supply passage 4 upstream of the ejector 10 differs depending on whether the bypass valve 12 is open or closed. In this embodiment, the state of the bypass valve 12 is determined in a step S21 and the detected pressure from the pressure sensor 18 is compared with a predetermined pressure corresponding to the determination result. Thus the hydrogen flow rate can be accurately determined. Consequently the pressure in the hydrogen supply passage 4 upstream of the ejector 10 can also be accurately controlled with respect to transient fluctuations in the flow rate as described with respect to the second embodiment.

If the purpose of the control of the bypass valve 12 is only the prevention of excessive increase in the pressure upstream of the ejector 10, the second predetermined pressure may be set equal to the first predetermined pressure.

However the reason for setting the second predetermined pressure to a value which is smaller than the first predetermined pressure is as follows. In the step S21, when the bypass valve 12 is closed and the detected pressure from the pressure sensor 18 has reached the first predetermined pressure, the bypass valve 12 is opened in the step S24. As a result, the pressure in the hydrogen supply passage 4 upstream of the ejector 10 is reduced. On the next occasion on which the routine is performed, the detected pressure from the pressure sensor 18 in the step S25 is compared with the second predetermined pressure since the bypass valve 12 is opened during the determination in the step S21.

When the second predetermined pressure is equal to the first predetermined pressure, the detected pressure from the pressure sensor 18 falls below the second predetermined pressure due to the pressure decrease described above and the bypass valve 12 is closed in a step S27.

This would result in the bypass valve 12 being opened or closed on each occasion the routine is performed. In order to avoid such a frequent opening and closing operation of the bypass valve 12, the second predetermined pressure is set to a smaller value than the first predetermined pressure. That is to say, a hysteresis region is provided in the pressure conditions related to opening and closing the bypass valve 12 by setting the second predetermined pressure to a smaller value than the first predetermined pressure.

In the first to third embodiments above, although an orifice 13 is provided in the bypass passage 11, it is possible to omit the orifice 13 by setting the open cross-sectional area of the bypass valve 12 to a small value or by pre-setting the flow cross-sectional area of the bypass passage 11 to a small value.

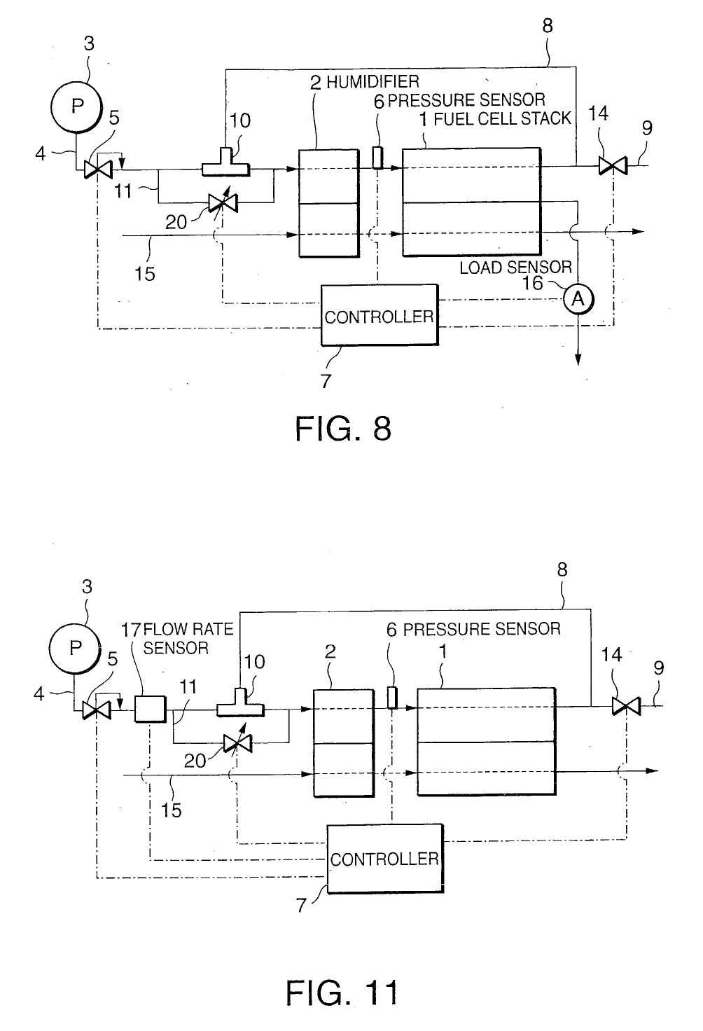

A fourth embodiment of this invention will be described with reference to FIGS. 8 to 10.

Firstly referring to FIG. 8, in this embodiment, a throttle 20 which continuously regulates the opening of the bypass passage 11 is provided instead of the orifice 13 and the bypass valve 12 of the first embodiment. Other aspects of the hardware structure are the same as those described with reference to the first embodiment.

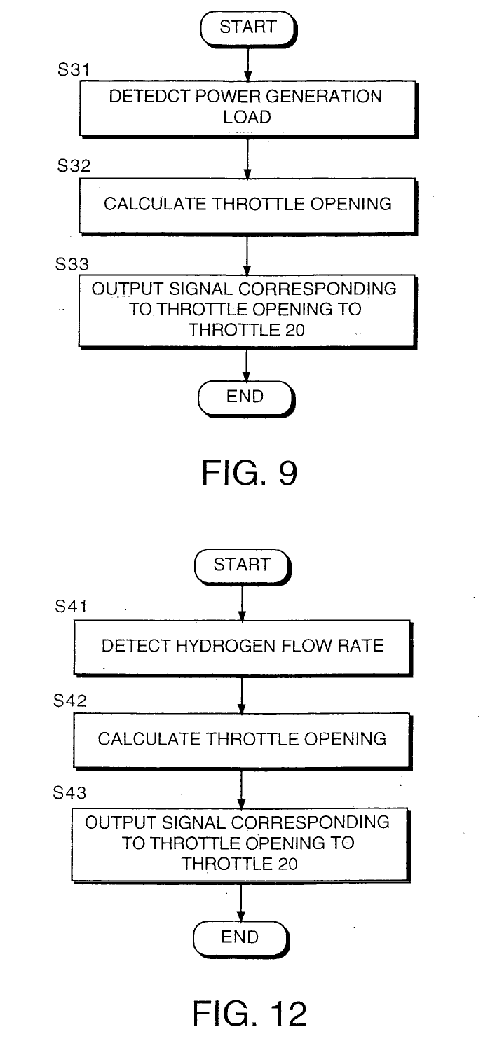

The controller 7 performs the routine shown in FIG. 9 in order to control the opening of the throttle 20.

Referring to FIG. 9, the controller 7 firstly reads the power generation load on the fuel cell stack 1 detected by the load sensor 16 in a step S31.

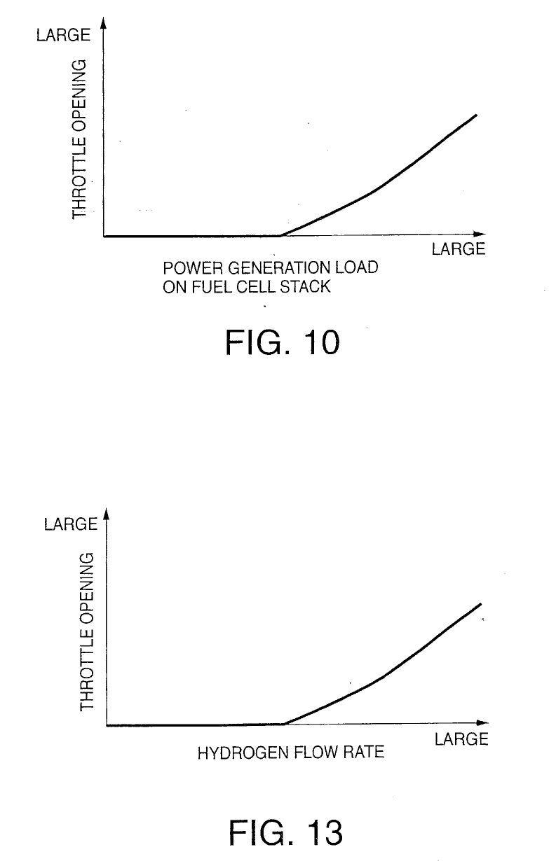

Then in a step S32, the throttle opening is calculated on the basis of the load by looking up a map having the characteristics shown in FIG. 10 which is pre-stored in the ROM.

Then in a step S33, a signal corresponding to the calculated throttle opening is output to the throttle 20. After the process in the step S33, the controller 7 terminates the routine.

In the map shown in FIG. 10, the opening of the throttle is maintained at a value of zero until the power generation load has reached the predetermined load. Thus in the same manner as the first embodiment, the anode effluent recirculation amount can be maintained in low-load regions while excessive increase in the pressure in the hydrogen supply passage 4 can be prevented in high-load regions.

A fifth embodiment of this invention will be described referring to FIGS. 11 to 13.

Firstly referring to FIG. 11, in this embodiment, a flow rate sensor 17 which is the same as that in the second embodiment is provided in the hydrogen supply passage 4 upstream of the bypass passage 11, while the load sensor 16 of the fourth embodiment is omitted instead. Other aspects of the hardware structure are the same as those described with reference to the fourth embodiment.

The controller 7 performs the routine shown in FIG. 12 instead of the routine shown in FIG. 9 of the fourth embodiment in order to control the opening of the throttle 20.

Referring to FIG. 12, the controller 7 firstly reads the hydrogen flow rate detected by the flow rate sensor 17 in a step S41.

Then in a step S42, the throttle opening is calculated on the basis of the hydrogen flow rate by looking up a map having the characteristics shown in FIG. 13 which is pre-stored in the ROM.

Then in a step S43, a signal corresponding to the calculated throttle opening is output to the throttle 20. After the process in the step S43, the controller 7 terminates the routine.

In the map shown in FIG. 13, the throttle 20 is closed as long as the hydrogen flow rate in the hydrogen supply passage 4 has reached a predetermined value. When the hydrogen flow rate has reached the predetermined value, the throttle begins to open and thereafter, the opening of the throttle 20 increases together with the increase in the hydrogen flow rate.

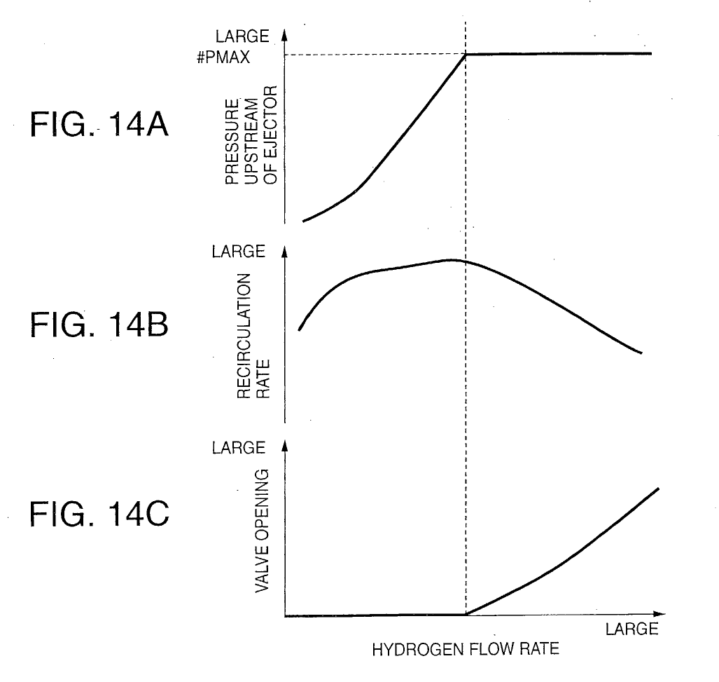

Referring to FIGS. 14A to 14C, these flow rate characteristics of the throttle 20 mean that the pressure in the hydrogen supply passage 4 upstream of the ejector 10 increases together with the hydrogen flow rate as long as the throttle 20 is closed. After the throttle 20 starts to open, the pressure stabilizes at a maximum permissible pressure of #Pmax. After that point, there are not further pressure increases. Thus it is possible to supply a large amount of hydrogen to the fuel cell stack 1 without resulting in an excessive increase in the pressure in the hydrogen supply passage 4. Since the hydrogen flow rate in the hydrogen supply passage 4 corresponds to the power generation load on the fuel cell stack 1, the same effect is obtained as the fourth embodiment which controls the opening of the throttle 20 in response to the power generation load.

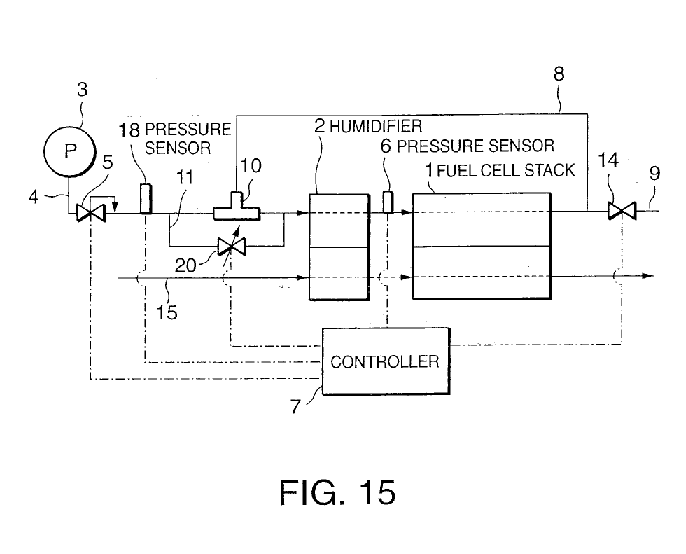

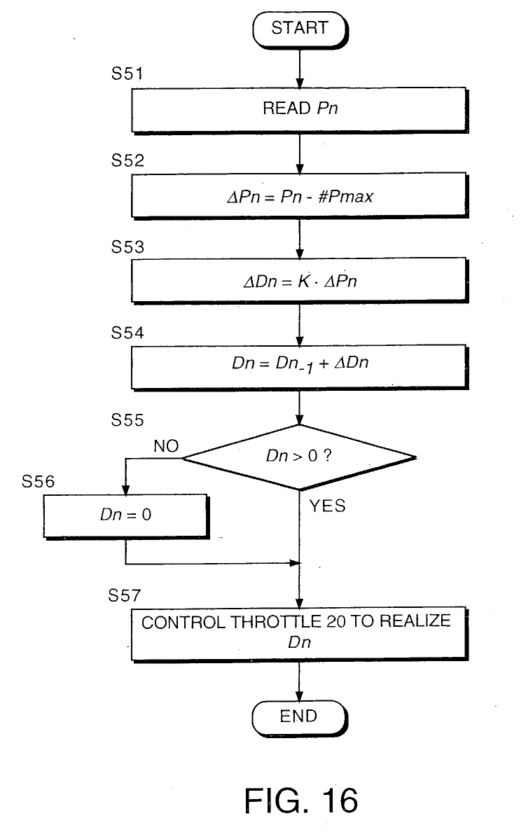

A sixth embodiment of this invention will be described referring to FIGS. 15 and 16.

Firstly referring to FIG. 15, in this embodiment, a pressure sensor 18 which is the same as that described in the third embodiment is provided in the hydrogen supply passage 4 upstream of the ejector 10 instead of the flow rate sensor 17 described in the fifth embodiment. Other aspects of the hardware structure are the same as those described with reference to the fifth embodiment.

The controller 7 performs the routine shown in FIG. 16 instead of the routine shown in FIG. 12 of the fifth embodiment in order to control the throttle 20.

Referring to FIG. 16, the controller 7 firstly reads a pressure Pn in the hydrogen supply passage 4 detected by the pressure sensor 18 in a step S51.

Then in a step S52, the differential pressure ΔPn is calculated as the difference of the pressure Pn and the maximum permissible pressure #Pmax in the hydrogen supply passage 4.

In a step S53, the differential pressure ΔPn is multiplied by a coefficient K in order to calculate a conversion value ΔDn which converts the differential pressure ΔPn into an opening in the throttle 20.

Then in a step S54, a value calculated by adding the conversion value ΔDn to the target opening Dn of the throttle 20 calculated on the immediately previous occasion the routine was executed is set as a new target opening Dn.

In the next step S55, it is determined whether or not the target opening Dn is greater than zero. When the target opening Dn is greater than zero, the routine proceeds to a step S57 and the opening of the throttle 20 is controlled to coincide with the target opening Dn.

When the target opening Dn is less than zero, that is to say, when it takes a negative value, the target opening is corrected to a value of zero in a step S56 and the process in the step S57 is performed. After the process in the step S57, the controller terminates the routine.

According to this embodiment, when the pressure Pn in the hydrogen supply passage 4 increases and exceeds the maximum permissible pressure #Pmax, the throttle 20 is opened. The opening of the throttle 20 at that time corresponds to an opening required to reduce the increased pressure Pn to the maximum permissible pressure #Pmax. Thus in this embodiment, it is also possible to maintain an anode effluent flow amount in the ejector 10 with respect to small hydrogen flow rates and to prevent excessive increase in the pressure of the hydrogen supply passage 4 upstream of the ejector 10 with respect to large hydrogen flow rates.

The contents of Tokugan 2001-350994, with a filing date of Nov. 16, 2001 in Japan, are hereby incorporated by reference.

Although the invention has been described above by reference to certain embodiments of the invention, the invention is not limited to the embodiments described above. Modifications and variations of the embodiments described above will occur to those skilled in the art, in light of the above teachings.

Industrial Field of Application

As mentioned above, the valve bypassing the ejector according to this invention maintains anode effluent recirculation performance of the ejector when the hydrogen flow rate is small, while preventing the pressure upstream of the ejector from becoming excessively large when the hydrogen flow rate is large. Therefore, by applying this invention to a fuel cell power plant for a vehicle, in which the hydrogen flow rate frequently varies, recirculation performance of anode effluent is enhanced.

1. A fuel cell power plant comprising:
a fuel cell stack (1) which generates an electric power by the reaction of air with hydrogen and discharges anode effluent which contains hydrogen;
a hydrogen supply passage (4) which supplies hydrogen to the fuel cell stack (1);
a recirculation passage (8) collecting the anode effluent discharged from the fuel cell stack (1);
an ejector (10) installed in the hydrogen supply passage (4) and ejecting the anode effluent from the recirculation passage (8) into the hydrogen supply passage (4) using a velocity head of hydrogen in the hydrogen supply passage (4); and
a valve (12, 20) which bypasses the ejector (10) and supplies hydrogen in the hydrogen supply passage (4) upstream of the ejector (10) to the fuel cell stack (1) without passing through the ejector (10).

2. The fuel cell power plant as defined in claim 1, wherein the fuel cell power plant further comprises a sensor (16, 17, 18) which detects a pressure in the hydrogen supply passage (4) upstream of the ejector (10), and a programmable controller (7) programmed to control the opening of the valve (12, 20) to prevent the pressure in the hydrogen supply passage (4) upstream of the ejector (10) from exceeding a predetermined pressure (S1-S3, S11-S13, S21-S27, S31-S33, S41-S43, S51-S57).

3. The fuel cell power plant as defined in claim 2, wherein the controller (7) is further programmed to open the valve (12, 20) when the pressure is greater than a first predetermined pressure and close the valve (12, 20) when the pressure is less than a second predetermined pressure which is less than the first predetermined pressure.

4. The fuel cell power plant as defined in claim 1, wherein the fuel cell power plant further comprises a sensor (16) which detects a power generation load on the fuel cell stack (1), and a programmable controller (7) programmed to control the valve (12, 20) to increase an opening of the valve (12, 20) corresponding to increases in the power generation load (S1-S3, S31-S33).

5. The fuel cell power plant as defined in claim 1, wherein the fuel cell stack (1) further comprises a sensor (17) which detects a hydrogen flow rate in the hydrogen supply passage (4) upstream of the ejector (10), and a programmable controller (7) programmed to control the valve (12, 20) to increase an opening of the valve (12, 20) corresponding to increases in the hydrogen flow rate (S11-S13, S41-S43).

6. The fuel cell power plant as defined in any one of claim 1 through claim 5, wherein the fuel cell power plant further comprises a bypass passage (11) bypassing the ejector (10), the valve (12) being disposed in the bypass passage, and an orifice (13) disposed in the bypass passage (11) in series with the valve (12, 20), and the valve (12, 20) comprises a valve (12) which selectively applies an open state or a closed state.

7. The fuel cell power plant as defined in any one of claim 1 through claim 5, wherein the valve (12, 20) comprises a throttle (20) which is continuously varied between an open state and a closed state.

8. The fuel cell power plant as defined in claim 7, wherein the fuel cell stack (1) further comprises a sensor (18) which detects a pressure in the hydrogen supply passage (4) upstream of the ejector (10), and a programmable controller (7) programmed to control the throttle (20) to an opening to cause the pressure to coincide with a predetermined pressure.
